(19) United States
(12) Patent Application Publication
(10) Pub. No.: US 2026/0277445 A1
(43) Pub. Date: Sep. 17, 2026

(54) MEMORY SYSTEM AND CONTROL METHOD

(71) Applicant: Kioxia Corporation, Tokyo (JP)

(72) Inventor: Rio YOSHIOKA, Yokohama Kanagawa (JP)

(73) Assignee: Kioxia Corporation, Tokyo (JP)

(21) Appl. No.: 19/328,439

(22) Filed: Sep. 15, 2025

(30) Foreign Application Priority Data
Mar. 14, 2025 (JP) 2025-041494

(51) Int. Cl. G06F 3/06

(52) U.S. Cl. CPC G06F 3/0613; G06F 3/0656; G06F 3/0679

(57) ABSTRACT

A memory system is provided that improves a transfer rate when a host's reception buffer has limited free space. According to one embodiment, the memory system includes a non-volatile memory and a controller. The controller is in communication with the host and controls the non-volatile memory. The controller acquires reception credit information from the host that indicates a size of free space available in the host's reception buffer. Based on the acquired reception credit information, the controller adjusts a size of the packet to be transmitted to the host.

### CROSS-REFERENCE TO RELATED APPLICATION

This application is based upon and claims the benefit of priority from Japanese Patent Application No. 2025-041494, filed Mar. 14, 2025, the entire contents of which are incorporated herein by reference.

### FIELD

Embodiments described herein relate generally to a memory system and a control method.

### BACKGROUND

A solid state drive (SSD) is connected to a host with an interface complying with PCI Express™ (PCIe™) standards and communicates with the host using protocol complying with NVM Express™ (NVMe™) standards.

In the PCIe(TM), a transmission side grasps a size of free space of a packet reception buffer of a counterpart (hereinafter, simply referred to as a reception buffer) and takes responsibility of controlling so as not to transmit a packet that cannot be stored in the reception buffer of the counterpart and overflows. The amount of available space in a reception buffer is communicated between devices using a flow control (FC) mechanism. Hereinafter, the ‘reception credit amount’ refers to information indicating the size of free space in a counterpart's reception buffer.

A drive such as an SSD can transmit data at a high transfer rate in a case where the reception buffer of the host has a sufficient size of free space. On the other hand, in a case where the reception buffer of the host has a small size of free space, there is a possibility that data cannot be transmitted at a high transfer rate.

### BRIEF DESCRIPTION OF THE DRAWINGS

FIG. 1 is a view illustrating a configuration example of a memory system of a first embodiment.

FIG. 2 is a view indicating flow of processing in a case where data is transmitted from the memory system of the first embodiment to a host.

FIG. 3 is a view as a comparative example indicating progress of data transfer in a case where transmission of a TLP is performed with an MPS in a condition where a reception credit amount of a counterpart is small.

FIG. 4 is a view indicating an example of a credit size/TLP transmission size correspondence table of the memory system of the first embodiment.

FIG. 5 is a sequence chart indicating flow of processing related to transmission of the TLP by the memory system of the first embodiment to the host.

FIG. 6 is a view indicating progress of data transfer in a case where the memory system of the first embodiment performs transmission of the TLP with a size determined in accordance with a reception credit amount of the host, along with a comparative example.

FIG. 7 is a flowchart indicating flow of operation regarding data transmission to the host by the memory system of the first embodiment.

FIG. 8 is a sequence chart indicating flow of processing related to transmission of the TLP to a host in a memory system of a second embodiment.

FIG. 9 is a flowchart indicating flow of operation regarding data transmission to the host by the memory system of the second embodiment.

FIG. 10 is a view illustrating a configuration example of a memory system of a third embodiment.

FIG. 11 is a flowchart indicating flow of operation regarding data transmission to a host by the memory system of the third embodiment.

### DETAILED DESCRIPTION

One embodiment provides a memory system and a control method capable of improving a transfer rate in a condition where a reception buffer of a host has a small size of free space.

In general, according to one embodiment, a memory system includes a non-volatile memory and a controller. The controller is capable of transmitting/receiving a packet to/from a host and controls the non-volatile memory. The controller acquires, from the host, information indicating a size of free space of a first volatile memory of the host to be used for reception of the packet and adjusts a size of the packet to be transmitted to the host based on the acquired information.

Embodiments will be described below with reference to the drawings.

### First Embodiment

First, a first embodiment will be described.

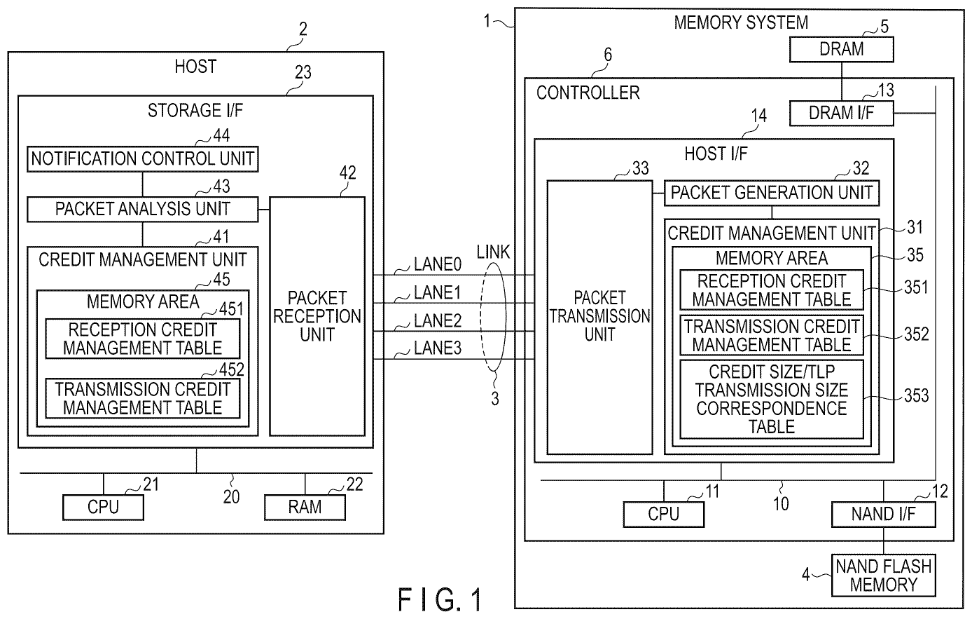

FIG. 1 is a view illustrating a configuration example of a memory system 1 of the first embodiment. FIG. 1 also illustrates an example where an information processing system is constructed by the memory system 1 being connected to a host 2 via a link 3. The link 3 is a serial interface complying with PCIe™ standards.

The host 2 is an information processing device that stores data in the memory system 1. The host 2 is, for example, a storage server that stores a large amount of and a wide variety of data in the memory system 1, or a personal computer.

The memory system 1 is a semiconductor storage device configured to write data in a non-volatile memory and read data from the non-volatile memory. The non-volatile memory is, for example, a NAND flash memory 4. The memory system 1 is also referred to as a storage device. The memory system 1 is, for example, implemented as a solid-state drive (SSD) including the NAND flash memory 4.

The memory system 1 can be used as a storage of the host 2. The memory system 1 can be connected to the host 2.

An interface for connecting the host 2 and the memory system 1 complies with standards such as PCIe™ and NVM Express™ (NVMe™).

### Configuration of Memory System 1

The memory system 1 includes, for example, the NAND flash memory 4, a dynamic random-access memory (DRAM) 5, and a controller 6.

The NAND flash memory 4 includes one or more memory chips. Each memory chip includes a memory cell array. The memory cell array includes a plurality of blocks. Each block includes a plurality of memory cells configured to store data in a non-volatile manner. Each of the plurality of blocks functions as a minimum unit of data erasure operation. The blocks are also referred to as erasure blocks or physical blocks. Each of the plurality of blocks includes a plurality of pages. Each of the plurality of pages includes a plurality of memory cells connected to a single word line. Each of the plurality of pages functions as a unit of data write operation and data read operation. Note that the word line may function as a unit of data write operation and data read operation.

The DRAM 5 is a volatile memory. A memory area of the DRAM 5 is, for example, allocated as a storage area of a firmware (FW), and a cache area of a logical-physical address conversion table. The memory area of the DRAM 5 may be allocated as a buffer area (reception buffer) for temporarily storing data received from outside and a buffer area for temporarily storing data to be transmitted to outside.

The controller 6 is a memory controller that controls the NAND flash memory 4 and the DRAM 5. The controller 6 is, for example, implemented by a circuit such as a system-on-a-chip (SoC).

The controller 6 includes, for example, a central processing unit (CPU) 11, a NAND interface circuit (NAND I/F) 12, a DRAM interface circuit (DRAM I/F) 13, and a host interface circuit (host I/F) 14. These CPU 11, the NAND I/F 12, the DRAM I/F 13, and the host I/F 14 may be connected via a bus 10. The controller 6 may further include a static random-access memory (SRAM). The SRAM is a volatile memory. The SRAM is, for example, connected to respective units within the controller 6 via the bus 10. The SRAM can store at least part of data (information) stored in the DRAM 5 described above.

The CPU 11 is a processor configured to control the NAND I/F 12, the DRAM I/F 13, and the host I/F 14. The CPU 11 performs various kinds of processing by executing FW loaded to the DRAM 5 from the NAND flash memory 4. The FW is a control program including commands for causing the CPU 11 to execute various kinds of processing. This processing includes command processing for processing various commands from the host 2. Operation of the CPU 11 is controlled by the FW to be executed by the CPU 11. The functions of the respective units within the controller 6 may be implemented by dedicated hardware within the controller 6 or may be implemented by the CPU 11 executing the FW.

The NAND I/F 12 electrically connects, i.e., provides a communication interface between the controller 6 and the NAND flash memory 4. The NAND I/F 12 supports interface standards such as toggle double data rate (toggle DDR), and open NAND flash interface (ONFI).

The NAND I/F 12 functions as a NAND control circuit configured to control the NAND flash memory 4. The NAND I/F 12 may be connected to a plurality of memory chips within the NAND flash memory 4 via a plurality of channels. As a result of the plurality of memory chips being driven in parallel, a bandwidth of access between the NAND flash memory 4 and the controller 6 can be made wider.

The DRAM I/F 13 functions as a DRAM control circuit configured to control access to the DRAM 5.

The host I/F 14 is a circuit that functions as an interface that performs communication between the memory system 1 and the host 2 (that is, external electronic equipment). The host I/F 14 includes a circuit for transmitting a packet to the host 2 and a circuit for receiving a packet from the host 2. The packet is, for example, a packet complying with the PCIe™ standards. Hereinafter, the packet will be also referred to as a transaction layer packet (TLP). The packet includes, for example, a command, a response or user data. The command is, for example, an input/output (I/O) command or a control command. The I/O command is, for example, a read command or a write command. The control command is, for example, an UNMAP command (TRIM command).

The host I/F 14 includes, for example, a credit management unit 31, a packet generation unit 32, and a packet transmission unit 33 as circuits for transmitting a packet to the host 2.

The credit management unit 31 is a circuit that manages credit in data transfer by the memory system 1 and the host 2 via the link 7 for each type. The credit is an index that becomes a base of flow control (FC) in the data transfer. For example, in a case where the memory system 1 and the host 2 comply with the PCIe standards, there are six types of the credit, that is, posted request headers (PH), posted request data payload (PD), non-posted request headers (NPH), non-posted request data payload (NPD), completion headers (CplH), and completion data payload (CplD). The flow control is control for electronic equipment 1T (here, the memory system 1) on the transmission side to transmit data in accordance with credit while preventing overflow of the reception buffer in electronic equipment 1R (here, the host 2) on the reception side.

The credit management unit 31 includes a memory area 35. In the memory area 35, for example, a reception credit management table 351, a transmission credit management table 352, and a credit size/TLP transmission size correspondence table 353 are stored. The reception credit management table 351 is data for managing a credit amount indicating an amount of data that can be received from outside (here, the host 2) for each type. The credit amount indicating the amount of data that can be received from outside is also referred to as a reception credit amount. The reception credit amount indicates a size of free space of a reception buffer within the controller 6. The transmission credit management table 352 is data for managing a credit amount indicating an amount of data that can be transmitted to outside for each type. The credit amount indicating the amount of data that can be transmitted to outside is also referred to as a transmission credit amount. The transmission credit amount indicates a size of free space of a reception buffer included in the host 2. The credit size/transaction layer packet (TLP) transmission size correspondence table 353 is a table in which a correspondence relationship between the size of free space (transmission credit amount) of the reception buffer of the host 2 and a size of the TLP to be transmitted to the host 2 is recorded. One example of the credit size/TLP transmission size correspondence table 353, and how the credit size/TLP transmission size correspondence table 353 is used and as a result what kind of effect is provided will be described later.

The credit management unit 31 manages the reception credit amount for each type using the reception credit management table 351. Specifically, in a case where communication with the host 2 is started, the credit management unit 31 determines and manages an initial value of the reception credit amount for each type based on a storage capacity of the reception buffer allocated to each of a plurality of types of the credit. Then, the credit management unit 31 manages a current reception credit amount for each type based on free space of the reception buffer corresponding to each type. The current reception credit amount of a certain type is, for example, a credit amount fluctuating from an initial value of the reception credit amount of the type in accordance with reception of data from the host 2 and processing of the data.

For example, in a case where data is newly stored in the reception buffer corresponding to a certain type, the credit management unit 31 updates the current reception credit amount of the type by subtracting the credit amount based on the amount of stored data from the current reception credit amount of the type. Further, in a case where data is discarded from the reception buffer corresponding to a certain type, the credit management unit 31 updates the current reception credit amount of the type by adding a credit amount based on the amount of the discarded data to the current reception credit amount of the type.

Further, the credit management unit 31 manages the transmission credit amount for each type using the transmission credit management table 352. Specifically, in a case where communication with the host 2 is started, the credit management unit 31 manages an initial value of the credit amount for each type notified by the host 2 (that is, the reception credit amount at the host 2) as an initial value of the transmission credit amount for each type. Then, the credit management unit 31 updates a current transmission credit amount of a certain type notified by the host 2 based on a change amount (increase and decrease) of the credit of the type. In other words, the current transmission credit amount of a certain type is, for example, a credit amount fluctuating from the initial value of the transmission credit amount of the type in accordance with transmission of data to the host 2 and processing of the data by the host 2.

For example, in a case where the host 2 makes a notification of a consumption amount of the credit of a certain type, the credit management unit 31 updates the current transmission credit amount of the type by subtracting the notified consumption amount from the managed transmission credit amount of the type. Further, in a case where the host 2 makes a notification of a restoration amount of the credit of a certain type, the credit management unit 31 updates the current transmission credit amount of the type by adding the notified restoration amount to the managed current transmission credit amount of the type.

The packet generation unit 32 is a circuit that generates a packet to be transmitted to the host 2. For example, in a case where the CPU 11 requests transmission of data to the host 2, the packet generation unit 32 generates a packet including at least part of the data. The data for which transmission is requested can include data to be used for transaction at the host 2. The packet generation unit 32 transmits the generated packet to the packet transmission unit 33. The packet generation unit 32 has a function of determining a TLP transmission size corresponding to a size of Credit of the host 2 with reference to the credit size/TLP transmission size correspondence table 353.

The packet transmission unit 33 is a circuit to be connected to the host 2 via a serial interface. This serial interface includes the link 7 capable of interconnecting the host 2 and the memory system 1. The packet transmission unit 33 corresponds to, for example, a physical layer (PCIe PHY) specified in the PCIe standards. The packet transmission unit 33 has, for example, a physical connection form complying with the PCIe standards. The packet transmission unit 33 performs interface operation of physically transmitting data via the link 7. Specifically, the packet transmission unit 33, for example, transmits the packet received from the packet generation unit 32 to the host 2 via the link 7.

The link 7 includes a plurality of lanes. Each of the plurality of lanes is a pair of a signal line for signal to be transmitted from the host 2 to the memory system 1 and a signal line for signal to be transmitted from the memory system 1 to the host 2. In FIG. 1, the link 7 including four lanes of a lane 0, a lane 1, a lane 2 and a lane 3 is illustrated as an example.

According to the configuration described above, the memory system 1 manages and controls data transmission to the host 2.

### Configuration of Host 2

The host 2 includes, for example, a CPU 21, a random-access memory (RAM) 22, and a storage interface circuit (storage I/F) 23. These CPU 21, the RAM 22, and the storage I/F 23 may be connected via a bus 20.

The CPU 21 is a processor configured to control the RAM 22 and the storage I/F 23. The CPU 21 performs various kinds of processing, for example, by executing programs loaded to the RAM 22. The programs to be executed by the CPU 21 include, for example, an operating system, a device driver, and an application program. The processing by the CPU 21 includes processing of issuing a command to the memory system 1 and receiving a response to the command. The operation of the CPU 21 is controlled by the program to be executed by the CPU 21. Functions of the respective units within the host 2 may be implemented by dedicated hardware within the host 2 or may be implemented by the CPU 21 executing the programs.

The RAM 22 is a volatile memory. A memory area of the RAM 22 is, for example, allocated as a storage area of a program. The memory area of the RAM 22 may be allocated as a buffer area (reception buffer) for temporarily storing data received from outside and a buffer area for temporarily storing data to be transmitted to outside.

The storage I/F 23 is a circuit that functions as an interface that performs communication between the host 2 and the memory system 1 (that is, external electronic equipment). The storage I/F 23 includes a circuit for transmitting a packet to the memory system 1 and a circuit for receiving a packet from the memory system 1.

The storage I/F 23 includes, for example, a credit management unit 41, a packet reception unit 42, a packet analysis unit 43, and a notification control unit 44 as circuits for receiving a packet from the memory system 1.

The credit management unit 41 is a circuit that manages credit in data transfer by the host 2 and the memory system 1 via the link 7 for each type. The credit management unit 41 includes a memory area 45. In the memory area 45, for example, a reception credit management table 451 and a transmission credit management table 452 are stored. The reception credit management table 451 is data for managing a credit amount (reception credit amount) indicating an amount of data that can be received from outside (here, the memory system 1) for each type. The transmission credit management table 352 is data for managing a credit amount (transmission credit amount) indicating an amount of data that can be transmitted to outside for each type.

The credit management unit 41 manages the reception credit amount for each type using the reception credit management table 451. Specifically, in a case where communication with the memory system 1 is started, the credit management unit 41 determines and manages an initial value of the reception credit amount for each type based on a storage capacity of the reception buffer allocated to each of a plurality of types of credit. Then, the credit management unit 41 manages a current reception credit amount for each type based on free space of the reception buffer corresponding to each type. The current reception credit amount of a certain type is, for example, a credit amount fluctuating from an initial value of the reception credit amount of the type in accordance with reception of data from the memory system 1 and processing of the data.

For example, in a case where data is newly stored in the reception buffer corresponding to a certain type, the credit management unit 41 updates the current reception credit amount of the type by subtracting the credit amount based on the amount of the stored data from the reception credit amount of the type. Further, in a case where data is discarded from the reception buffer corresponding to a certain type, the credit management unit 41 updates the current reception credit amount of the type by adding the credit amount based on the amount of the discarded data to the current reception credit amount of the type.

Further, the credit management unit 41 manages the transmission credit amount for each type using the transmission credit management table 452. Specifically, in a case where communication with the memory system 1 is started, the credit management unit 41 manages an initial value of the credit amount for each type notified by the memory system 1 (that is, the reception credit amount at the memory system 1) as the initial value of the transmission credit amount for each type. Then, the credit management unit 41 updates a current transmission credit amount of a certain type notified by the memory system 1 based on a change amount of the credit of the type. In other words, the current transmission credit amount of a certain type is, for example, a credit amount fluctuating from the initial value of the transmission credit amount of the type in accordance with transmission of data to the memory system 1 and processing of the data by the memory system 1. Note that information indicating the change amount of the credit is, for example, included in a packet to be transmitted from the memory system 1 to the host 2.

For example, in a case where the memory system 1 makes a notification of a consumption amount of credit of a certain type, the credit management unit 41 updates the current transmission credit amount of the type by subtracting the notified consumption amount from the managed transmission credit amount of the type. Further, in a case where the memory system 1 makes a notification of a restoration amount of credit of a certain type, the credit management unit 41 updates the current transmission credit amount of the type by adding the notified restoration amount to the managed transmission credit amount of the type.

The packet reception unit 42 is a circuit to be connected to the memory system 1 via a serial interface (more specifically, the link 7). The packet reception unit 42, for example, corresponds to a physical layer specified in the PCIe standards. The packet reception unit 42 has, for example, a physical connection form complying with the PCIe standards. The packet reception unit 42 performs interface operation of physically receiving data via the link 7. Specifically, the packet reception unit 42, for example, receives a packet from the host 2 via the link 7. The packet reception unit 42 transmits the received packet to the packet analysis unit 43.

The packet analysis unit 43 is a circuit that analyzes the packet received from the packet reception unit 42. Specifically, the packet analysis unit 43 performs error detection/correction processing on data included in the packet. In a case where an error is not detected or in a case where the detected error is corrected, processing using the data included in the packet is performed. Specifically, data to be used for transaction at the host 2 within the packet is, for example, processed by the storage I/F 23 and the CPU 21. Further, in a case where credit information representing the reception credit amount for each type in the memory system 1 is included in the packet, the packet analysis unit 43 can determine for each type, whether or not the credit information corresponds to the transmission credit amount managed by the credit management unit 41. In other words, the packet analysis unit 43 can determine whether or not the transmission credit amount for the memory system 1 is correctly managed in the transmission credit management table 452 based on the credit information representing the reception credit amount for each type in the memory system 1. The packet analysis unit 43 transmits the determination result for each type to the notification control unit 44.

The notification control unit 44 controls notification (output) based on the determination result received from the packet analysis unit 43. Specifically, the notification control unit 44, for example, outputs an error in accordance with a fact that the credit information within the packet does not correspond to the transmission credit amount managed in the transmission credit management table 452 for a certain type. Further, the notification control unit 44 may output information indicating whether or not the credit information within the packet corresponds to the transmission credit amount managed in the transmission credit management table 452 for each type. Alternatively, the notification control unit 44 may output information indicating a type for which the credit information does not correspond to the transmission credit amount.

According to the configuration described above, the host 2 manages and controls data transfer to the memory system 1.

Note that the host I/F 14 of the memory system 1 further includes components similar to the packet reception unit 42, the packet analysis unit 43, and the notification control unit 44. In other words, the host I/F 14 can perform reception of the packet including the credit information for each type, analysis of the packet, and output in accordance with the analysis result in a similar manner to the storage I/F 23 described above.

Further, the storage I/F 23 of the host 2 further includes components similar to the packet generation unit 32 and the packet transmission unit 33. In other words, the storage I/F 23 can perform transmission of Flit 8 including the credit information for each type in a similar manner to the host I/F 14 described above.

By the way, at the host 2, various kinds of operation are executed by the CPU 21. For example, in a case where data is read from a file stored in the memory system 1, a read command is issued from the CPU 21 to the memory system 1 via the storage I/F 14. The memory system 1 determines a size of the TLP and transmits the TLP including data read in response to the read command to the host 2.

The CPU 21 receives the TLP transmitted from the memory system 1 and stores the TLP in the reception buffer of the host 2. Then, the CPU 21 reads data from a storage position of the data within the reception buffer. If read of the data from the reception buffer is completed, the CPU 21 releases an area within the reception buffer in which the data is stored. The released area can be used as an area for storing subsequent data.

For example, if the reception buffer of the host 2 becomes full, the packet transmission unit 33 of the memory system 1 stands by for transmission of the data by the TLP until the reception buffer of the host 2 is available. A state where the reception buffer of the host 2 becomes full can include a state where a size of free space of the reception buffer becomes 0 Byte, and a state where a size of free space of the reception buffer becomes smaller than a size of the TLP. In other words, if the reception credit amount of the host 2 becomes smaller than the size of the TLP, the memory system 1 stands by for transmission of the TLP until the reception credit amount of the host 2 becomes larger than the size of the TLP. As a result, if the packet reception of the host 2 becomes full, a transfer rate decreases. In other words, if the reception credit amount of the host 2 becomes smaller than the size of the TLP, the transfer rate decreases.

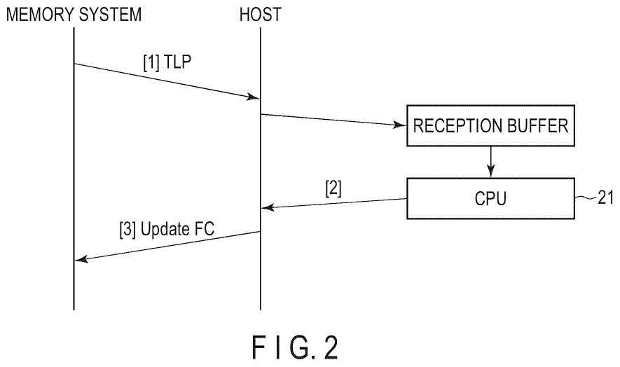

FIG. 2 indicates flow of processing in a case where the memory system 1 transmits data to the host 2.

A series of processing of transmitting data from the memory system 1 to the host 2 include three kinds of operation of [1] TLP transmission, [2] Host processing, and [3] Update FC as indicated in FIG. 2.

TLP transmission is operation of transmitting the TLP from the memory system 1 to the host 2. The transmitted TLP is received at the packet reception unit 42 of the host 2, stored in the reception buffer within the RAM 22 and analyzed at the packet analysis unit 43. [2] Host processing is operation of the CPU 21 internally processing data included in the TLP received by the host 2 from the memory system 1. [3] Update FC is operation of notifying a counterpart of a size of free space of the reception buffer in a case where the size of free space of the reception buffer fluctuates, determined as part of FC. The host 2 notifies the memory system 1 of completion of data processing and increase of the reception credit amount (increase of the size of free space of the reception buffer). In each step, latency as described below occurs.
[1] Latency of TLP transmission: a period until the TLP is transmitted from the memory system 1 to the host 2
[2] Latency of Host processing: a period until processing of the data received by the host 2 with the TLP is completed
[3] Latency of Update FC: a period until data processing is completed, and the host 2 notifies the memory system 1 of increase of the reception credit amount

In a case where the reception credit amount of the host 2 is smaller than the size of the TLP, these kinds of operation do not circulate well. More specifically, a situation occurs where the memory system 1 stands by for transmission of the next data until the three kinds of operation of [1] TLP transmission, [2] Host processing, and [3] Update FC are completed for the data transmitted from the memory system 1 previous time.

For example, there is a case where the TLP is transmitted with a maximum payload size (MPS) to improve a transfer rate between the memory system 1 and the host 2.

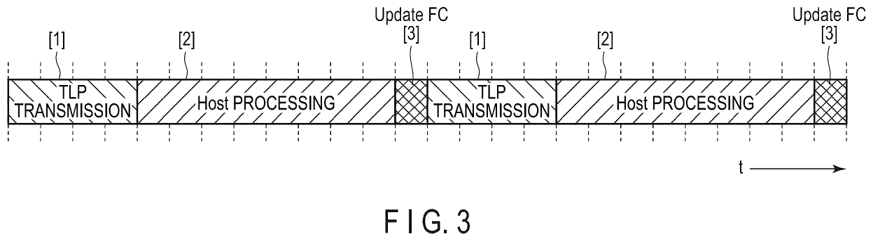

FIG. 3 is a view as a comparative example indicating progress of data transfer in a case where transmission of the TLP is performed with the MPS in a condition where the reception credit amount of the counterpart is smaller than the size of the TLP. Here, for example, a case is assumed where the reception credit amount of the counterpart is 512 Bytes, and the transmission size of the TLP is also 512 bytes. In other words, in this comparative example, the TLP is transmitted with the MPS.

In this comparative example, every time the TLP storing data is transmitted ([1]), the reception credit amount of the counterpart becomes insufficient. Thus, transmission of the next TLP is in a standby state until processing of the immediately preceding TLP is completed, the storage area is released ([2]), and a notification of completion of the processing of the TLP and increase of the reception credit amount is made ([3]).

In this manner, there is a possibility that latency may increase in a case where transmission of the TLP with the MPS is performed in a case where the reception credit amount of the counterpart is small.

Thus, in the memory system 1 of the first embodiment, the size of the TLP to be transmitted to the host 2 is dynamically changed in accordance with the reception credit amount of the host 2 to implement efficient transmission of the TLP. In other words, the memory system 1 of the first embodiment achieves improvement in a transfer rate in a condition where the reception credit amount of the host 2 is small. Hereinafter, the size of the TLP to be transmitted from the memory system 1 to the host 2 will be also referred to as a transmission TLP size.

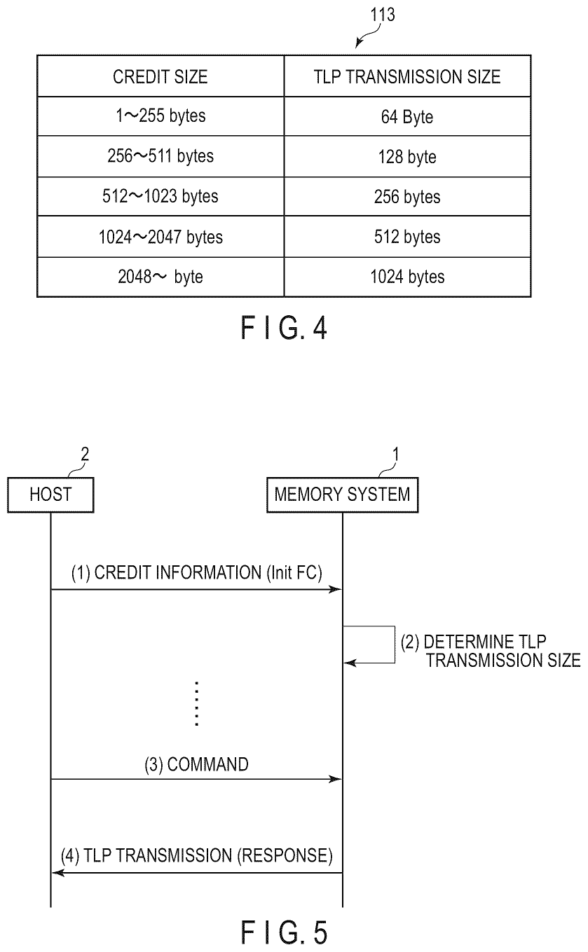

FIG. 4 is a view indicating an example of the credit size/TLP transmission size correspondence table 353.

In the example of FIG. 4, the credit size/TLP transmission size correspondence table 353 indicates that the TLP transmission size is set at 64 bytes in a case where the reception credit amount of the host 2 is from 1 to 255 Bytes. The TLP transmission size is set at 128 bytes in a case where the reception credit amount of the host 2 is from 256 to 511 Bytes. The TLP transmission size is set at 256 bytes in a case where the reception credit amount of the host 2 is from 512 to 1023 Bytes. The TLP transmission size is set at 512 bytes in a case where the reception credit amount of the host 2 is from 1024 to 2047 Bytes. The TLP transmission size is set at 1024 bytes in a case where the reception credit amount of the host 2 is equal to or larger than 2048 Bytes. In other words, each of reception credit amounts may serve as a threshold for setting the TLP transmission size. In particular, in accordance with embodiments, an adjusted transmission size of the TLP is smaller than a MPS supported by the host when the acquired reception credit information indicates the size of free space is below a predetermined threshold.

Subsequently, how the credit size/TLP transmission size correspondence table 353 is used, and as a result, what kind of effects are provided will be described.

FIG. 5 is a sequence chart indicating flow of processing related to transmission of the TLP to the host 2 in the memory system 1 of the first embodiment.

The host I/F 14 is notified of information regarding the reception credit amount of the host 2 from the storage I/F 23 by Init FC upon formation of the link 3 ((1) of FIG. 5). The credit management unit 31 acquires information regarding credit of the host 2. The information regarding credit described here is the reception credit amount of the host 2.

The packet generation unit 32 determines a transmission size of the TLP based on the reception credit amount of the host 2 acquired and managed by the credit management unit 31 with reference to the credit size/TLP transmission size correspondence table 353 ((2) of FIG. 5). In this manner, the credit size/TLP transmission size correspondence table 353 is used to dynamically determine the TLP transmission size in accordance with the reception credit amount of the host 2.

Then, for example, if a read command is received from the host 2 ((3) of FIG. 5), the controller 6 reads the data from the NAND flash memory 4. The packet transmission unit 33 transmits the read data to the host 2 using the TLP of the size determined and generated by the packet generation unit 32 ((4) of FIG. 5).

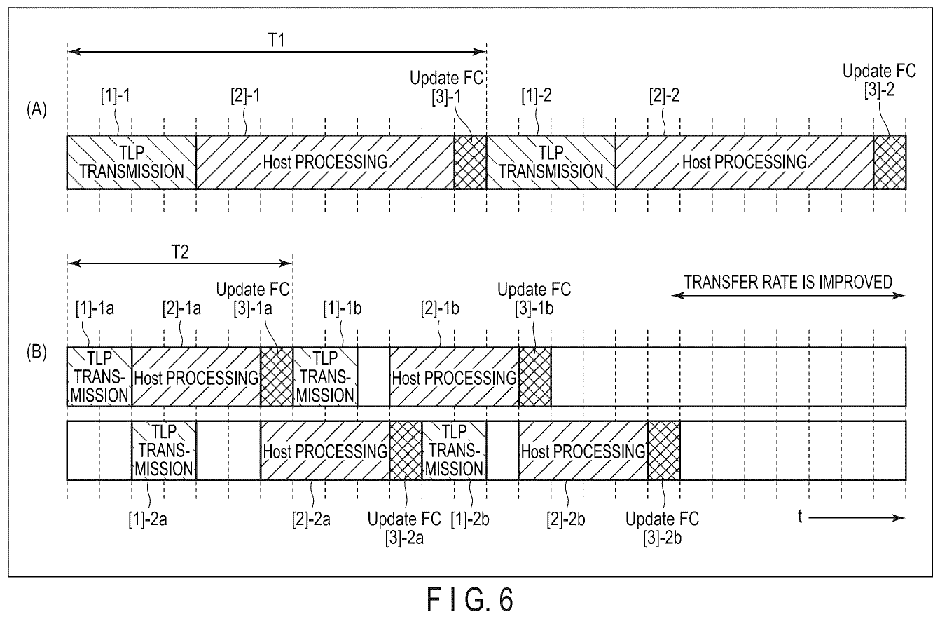

FIG. 6 is a view indicating progress of data transfer in a case where the memory system 1 of the first embodiment transmits the TLP of the size determined in accordance with the reception credit amount of the host 2, along with the comparative example described above.

The part (A) of FIG. 6 indicates progress of data transfer in the comparative example also indicated in FIG. 3. On the other hand, the part (B) of FIG. 6 is progress of data transfer in the memory system 1 of the first embodiment. As described in the comparative example, here, the reception credit amount of the counterpart (host 2) is 512 Bytes.

In the memory system 1 of the first embodiment, the credit management unit 31 acquires the reception credit amount of the host 2. The packet generation unit 32 acquires the transmission size of the TLP corresponding to the reception credit amount of the host 2 from the credit size/TLP transmission size correspondence table 353.

Here, the reception credit amount of the host 2 is 512 Bytes, and thus, 256 Bytes is acquired as the TLP transmission size from the credit size/TLP transmission size correspondence table 353 in FIG. 4. Thus, the memory system 1 transmits the TLP of a size (256 bytes) that is half of the reception credit amount of the host 2, to the host 2 ([1]-1a in the part (B)).

The TLP transmitted to the host 2 from the memory system 1 is stored in the reception buffer of the host 2. If the first TLP is transmitted from the memory system 1 to the host 2, the host 2 starts processing of data included in the received TLP ([2]-1a in the part (B)). In this event, the reception credit amount of the host 2 is 256 Bytes. The memory system 1 transmits the second TLP to the host 2 with a size of 256 Bytes in a similar manner to the first TLP ([1]-2a in the part (B)).

If the memory system 1 transmits the second TLP to the host 2, the reception credit amount of the host 2 becomes 0 Byte (that is, the reception buffer of the host 2 becomes full). In other words, the reception credit amount of the host 2 becomes insufficient, and the memory system 1 stands by for data transmission of the third TLP to the host 2. However, unlike with the comparative example, processing of the host 2 regarding the first TLP ([2]-1a in the (B)) is made to proceed in parallel to start of transmission of the second TLP by the memory system 1. Further, a target data amount of the processing of the host 2 regarding the second TLP is half of the data amount in the comparative example. Thus, after the processing of the host 2 regarding the first TLP is completed, a period T2 until the memory system 1 is notified of increase of the reception credit amount of the host 2 from the host 2 ([3]-1a in the part (B)) is shorter than a period T1 in the comparative example ([3]-1 in the part (A)). Thus, the memory system 1 can transmit the third TLP (corresponding to the first half of the second TLP in the comparative example) at a timing earlier than the comparative example ([1]-1b in the part (B)).

Also when the memory system 1 transmits the third TLP to the host 2, in a similar manner to when the memory system 1 transmits the second TLP to the host 2 described above, the reception credit amount of the host 2 becomes 0 Byte (that is, the reception buffer of the host 2 becomes full), and the reception credit amount becomes insufficient. Thus, the memory system 1 stands by for data transmission of the fourth TLP to the host 2. Processing of the host 2 regarding the second TLP ([2]-2a in the part (B)) is started immediately after the processing of the host 2 regarding the first TLP is completed. Further, a target data amount of the processing of the host 2 regarding the first TLP is half of the data amount transmitted in the comparative example ([1]-1 in the part (A)). Thus, a period until the memory system 1 is notified of completion of the processing of the host 2 regarding the second TLP and increase of the reception credit amount of the host 2 ([3]-2a in the part (B)) is also shorter than that in the comparative example ([3]-1 in the part (A)). Thus, the memory system 1 can also transmit the fourth TLP (corresponding to the second half of the second TLP of the comparative example) at a timing earlier than the comparative example ([1]-2b in the part (B)).

In this manner, the memory system 1 of the first embodiment can improve a transfer rate in a condition where the reception credit amount of the host is small by setting the size of the TLP short depending on the reception credit amount of the host 2. In other words, when a “full” state causes the transmission pipeline to stall, use of a smaller packet size mitigates the duration of this stall, resulting in a more continuous flow of data, improving the overall transfer rate.

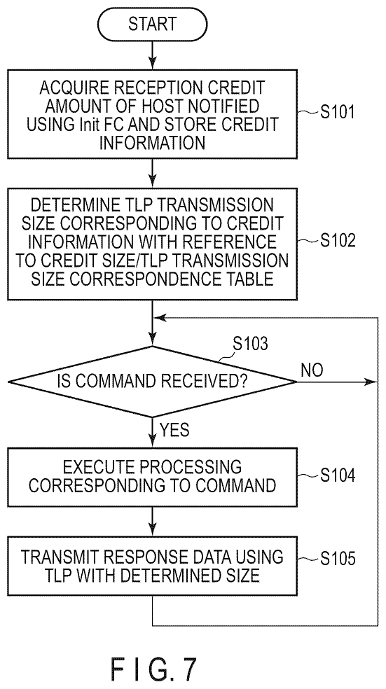

FIG. 7 is a flowchart indicating flow of operation regarding data transmission to the host 2 by the memory system 1 of the first embodiment.

Upon PCIe™ setting procedure between the host I/F 14 of the memory system 1 and the storage I/F 23 of the host 2, the memory system 1 receives Init FC from the host 2. The credit management unit 31 of the memory system 1 acquires the reception credit amount of the host 2 by Init FC and stores credit information (S101). The acquired credit information is the reception credit amount of the host 2.

The packet generation unit 32 determines a size of the TLP to be transmitted to the host 2, corresponding to the acquired credit information with reference to the credit size/TLP transmission size correspondence table 353 (S102).

The memory system 1 determines whether or not a command is received from the host 2 (S103). In a case where a command is received from the host 2 (S103: Yes), the controller 6 executes processing corresponding to the received command (S104). The controller 6 transmits response data to the host 2 as a result of the processing corresponding to the received command. The packet transmission unit 33 transmits the response data to the host 2 using the TLP of the size determined and generated by the packet generation unit 32 (S105). If the transmission of the TLP is completed, the processing returns to S103, and the memory system 1 stands by until a command is received from the host 2.

Further, also in a case where a command is not received from the host 2 (S103: No), the memory system 1 continuously stands by until a command is received from the host 2 in S103. The processing from S103 to S105 is repeated while the PCIe™ interface 3 is formed between the host 2 and the memory system 1. In other words, when connection with the host 2 is disconnected, the operation of the memory system 1 indicated in FIG. 7 ends.

As described above, the memory system 1 of the first embodiment dynamically changes the size of the TLP to be transmitted to the host 2 in accordance with the reception credit amount of the host 2 notified using Init FC. This reduces a case where the memory system 1 stands by for transmission of the TLP to the host 2 due to an insufficient reception credit amount of the host 2. Further, as a result of the memory system 1 transmitting the TLP of the size in accordance with the reception credit amount of the host 2, a period required for the host 2 to process one TLP is shortened, so that a period until the reception credit amount of the host 2 increases can be shortened. This enables the memory system 1 of the first embodiment to implement efficient TLP transmission. In other words, the memory system 1 of the first embodiment achieves improvement in a transfer rate in a condition where the reception buffer of the host 2 is small.

### Second Embodiment

A second embodiment will be described next.

The second embodiment will be described also using an example of a memory system implemented as an SSD in a similar manner to the first embodiment. Components that are the same as the components of the memory system 1 of the first embodiment will be denoted by the same reference numerals, and description thereof will be omitted.

In the memory system 1 of the first embodiment, the credit management unit 31 acquires the reception credit amount of the host 2 notified with Init FC from the host 2 as the credit information. The credit information is temporarily stored in a volatile memory (not illustrated) such as a register or an SRAM. The volatile memory is, for example, included in the credit management unit 31. The packet generation unit 32 determines the TLP transmission size in accordance with the acquired credit information.

In the memory system 1 of the second embodiment, the credit management unit 31 further acquires free space occurring in the reception buffer notified using Update FC as the credit information. In other words, the credit management unit 31 further acquires fluctuation of the reception credit amount notified using Update FC as the credit information. More specifically, the credit management unit 31 of the second embodiment updates the credit information using the reception credit amount of the host 2 notified using Update FC. The packet generation unit 32 of the second embodiment determines the TLP transmission size in accordance with the updated credit information with reference to the credit size/TLP transmission size correspondence table 353.

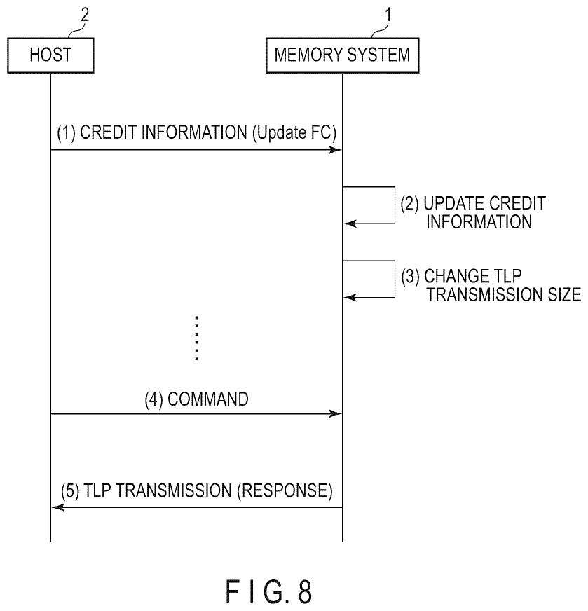

FIG. 8 is a sequence chart indicating flow of processing related to transmission of the TLP to the host 2 in the memory system 1 of the second embodiment.

The host I/F 14 receives a notification of the information regarding credit of the host 2 by Update FC from the storage I/F 23 of the host 2 ((1) of FIG. 8). The information regarding credit is the reception credit amount of the host 2 here.

The packet generation unit 32 updates the credit information using the acquired reception credit amount of the host 2 ((2) of FIG. 8). Subsequently, the packet generation unit 32 determines the transmission size of the TLP based on the updated credit information with reference to the credit size/TLP transmission size correspondence table 353 ((3)) of FIG. 8).

Then, in a similar manner to the first embodiment, for example, if a read command is received from the host 2 ((4) of FIG. 8), the packet transmission unit 33 transmits the data read from the NAND flash memory 4 by the controller 6 to the host 2 using the TLP of the size determined and generated by the packet generation unit 32 ((5) of FIG. 8).

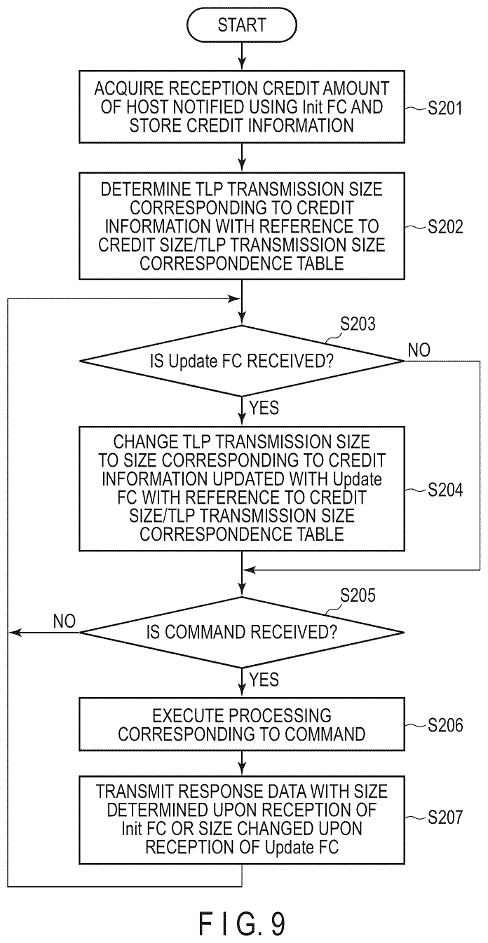

FIG. 9 is a flowchart indicating flow of operation regarding data transmission to the host 2 by the memory system 1 of the second embodiment.

Upon PCIe™ setting procedure between the host I/F 14 of the memory system 1 and the storage I/F 23 of the host 2, the memory system 1 receives Init FC from the host 2. The credit management unit 31 of the memory system 1 acquires the reception credit amount of the host 2 by Init FC and stores the credit information (S201).

The packet generation unit 32 determines the size of the TLP to be transmitted to the host 2, corresponding to the credit information with reference to the credit size/TLP transmission size correspondence table 353 (S202).

In a case where the host I/F 14 receives Update FC from the host 2 (S203: Yes), the credit management unit 31 updates the credit information using the reception credit amount included in Update FC. The packet generation unit 32 changes the size of the TLP to be transmitted to the host 2 to the size corresponding to the updated credit information with reference to the credit size/TLP transmission size correspondence table 353 (S204). Note that in a case where Update FC is not received from the host 2 (S203: No), the processing of S204 is skipped.

Then, in a case where a command is received from the host 2 (S205: Yes), the controller 6 executes processing corresponding to the command (S206). The controller 6 transmits response data to the host 2 as a result of the processing corresponding to the received command. The packet transmission unit 33 transmits the response data to the host 2 using the TLP of the size determined in S202 or changed in S204 (S207). After transmission of the TLP is completed, the processing returns to S203, and the memory system 1 stands by until Update FC or a command is received from the host 2.

Further, also in a case where it is determined that a command from the host 2 is not received (S205: No), the processing returns to S203, and the memory system 1 stands by until Update FC or a command is received from the host 2.

As described above, the memory system 1 of the second embodiment dynamically changes the size of the TLP to be transmitted to the host 2 in accordance with the reception credit amount of the host 2 by Update FC to implement efficient TLP transmission. In other words, the memory system 1 of the second embodiment achieves improvement in a transfer rate in a condition where an amount of credit of the host 2 is small.

### Third Embodiment

A third embodiment will be described next.

The third embodiment will be described using an example of a memory system implemented as an SSD in a similar manner to the first embodiment. Components that are the same as the components of the memory system 1 of the first embodiment will be denoted by the same reference numerals, and description thereof will be omitted.

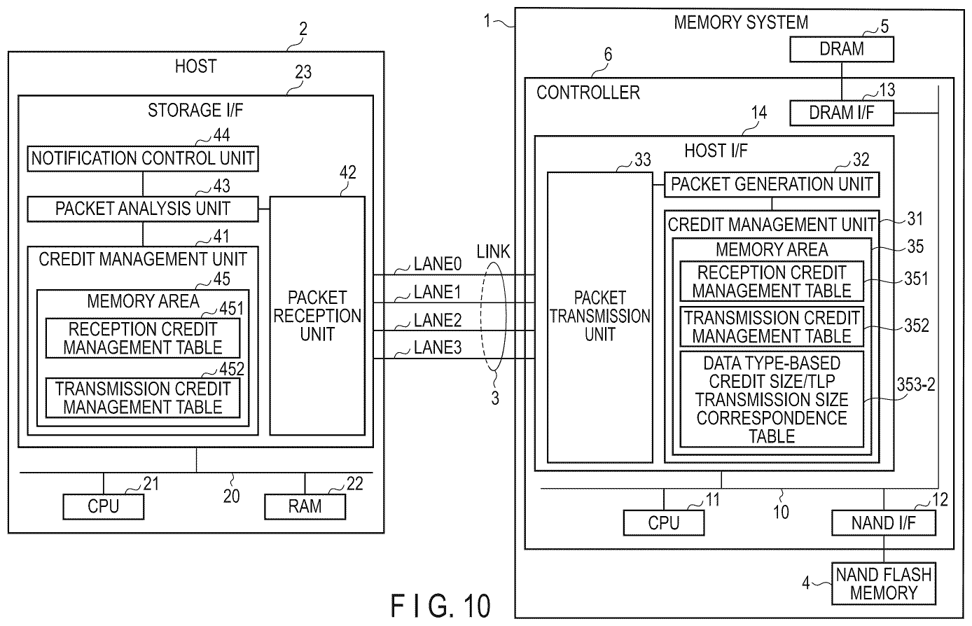

FIG. 10 is a view illustrating a configuration example of the memory system 1 of the third embodiment.

The memory system 1 of the third embodiment has the credit size/TLP transmission size correspondence table 353 for each type of data. This will be referred to as a data type-based credit size/TLP transmission size correspondence table 353-2.

For example, a period required for “[2] Host processing” indicated in FIG. 3 may be different depending on types of data. In other words, the transmission size of the TLP appropriate for the size of the credit of the host 2 may be different depending on types of data. The memory system 1 of the third embodiment dynamically changes the size of the TLP to be transmitted to the host 2 in accordance with the reception credit amount of the host 2 for each type of data to be transmitted to the host from the memory system 1.

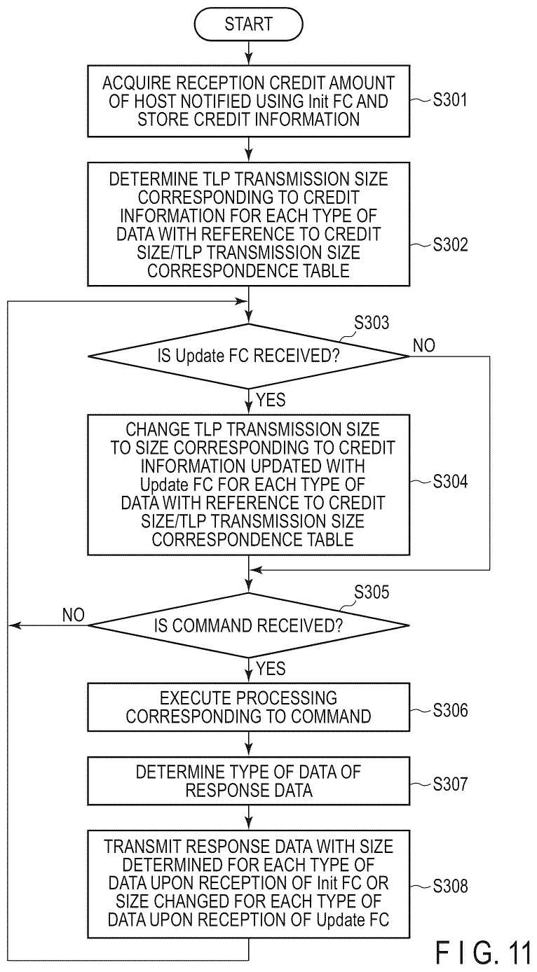

FIG. 11 is a flowchart indicating flow of operation regarding data transmission to the host by the memory system of the third embodiment.

Upon PCIe™ setting procedure between the host I/F 14 of the memory system 1 and the storage I/F 23 of the host 2, the memory system 1 receives Init FC from the host 2. The credit management unit 31 of the memory system 1 acquires the reception credit amount of the host 2 by Init FC and stores the credit information (S301).

The packet generation unit 32 determines the size of the TLP to be transmitted to the host 2, corresponding to the credit information for each type of data with reference to the data type-based credit size/TLP transmission size correspondence table 353-2 (S302).

In a case where Update FC is received from the host 2 by the host I/F 14 (S303: Yes), the credit management unit 31 updates the credit information using the reception credit amount of the host 2 included in Update FC. The packet generation unit 32 refers to the data type-based credit size/TLP transmission size correspondence table 353-2. The packet generation unit 32 changes the size of the TLP to be transmitted to the host 2 for each type of data to be transmitted to the host 2 (S304). This size of the TLP is a size corresponding to the updated credit information. Note that in a case where Update FC is not received from the host 2 (S303: No), the processing of S304 is skipped.

The memory system 1 determines whether or not a command is received from the host 2 (S305). In a case where a command is received from the host 2 (S305: Yes), the controller 6 executes processing corresponding to the command (S306). The controller 6 transmits response data to the host 2 as a result of the processing corresponding to the received command. The packet generation unit 32 determines a type of data of the response data (S307). The packet transmission unit 33 transmits the response data to the host 2 with the TLP of the size determined for each type of data in S302 or changed for each type of data in S304 (S307). If transmission of the TLP is completed, the processing returns to S303, and the memory system 1 stands by until Update FC or a command is received from the host 2.

Further, also in a case where a command is not received from the host 2 (S305: No), the processing returns to S303, and the memory system 1 stands by until Update FC or a command is received from the host 2.

As described above, the memory system 1 of the second embodiment implements efficient TLP transmission by further dynamically changing the size of the TLP to be transmitted to the host 2 in accordance with the size of the credit of the host 2 or an size of free space of the credit at that time of the host 2 for each type of data for which a period required for the processing at the host 2 may be different. In other words, the memory system 1 of the third embodiment achieves improvement in a transfer rate in a condition where a credit amount of the host 2 is small.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is

1. A memory system comprising:
a non-volatile memory; and
a controller configured to communicate with a host via an interface and to control the non-volatile memory, wherein
the controller is further configured to:
acquire, from the host, reception credit information indicating a size of free space of a reception buffer of the host, and
adjust a transmission size of a packet to be transmitted to the host based on the acquired reception credit information.

2. The memory system of claim 1, wherein
the reception credit information includes a reception credit amount indicating an amount of the packet that can be received by the host.

3. The memory system of claim 1, wherein
the controller is further configured to:
acquire the reception credit information by a first notification transmitted from the host upon establishment of a communication link with the host, and
adjust the transmission size of the packet based on the reception credit information acquired by the first notification.

4. The memory system of claim 1, wherein
the controller is further configured to:
acquire the reception credit information by a second notification transmitted from the host when the size of free space of the reception buffer of the host changes, and
adjust the transmission size of the packet based on the reception credit information acquired by the second notification.

5. The memory system of claim 1, wherein
the controller includes a memory storing a first table that defines a relationship between the size of free space of the host and the transmission size of the packet, and
the controller is configured to determine the transmission size of the packet with reference to the first table.

6. The memory system of claim 5, wherein the first table associates smaller transmission sizes with smaller sizes of free space.

7. The memory system of claim 1, wherein the controller is configured to adjust the transmission size of the packet based on the information for each type of data included in the packet to be transmitted to the host.

8. The memory system of claim 1, wherein the controller communicates with the host in compliance with PCI Express™ (PCIe™) standards.

9. The memory system of claim 1, wherein the adjusted transmission size is smaller than a maximum payload size (MPS) supported by the host when the acquired reception credit information indicates the size of free space is below a predetermined threshold.

10. A controller for a memory system, the controller comprising:
a host interface circuit configured to communicate with a host;
a packet generation circuit coupled to the host interface circuit, the packet generation circuit being configured to: acquire, via the host interface circuit, reception credit information indicating a size of free space of a reception buffer of the host;
determine a transmission size of a packet to be transmitted to the host based on the acquired reception credit information; and
generate a size of the packet to be transmitted to the host based on the transmission size.

11. The controller of claim 10, wherein
the packet generation circuit is configured to acquire, via the host interface, second reception credit information indicating a size of free space when the size of free space of the host changes,
dynamically adjust the transmission size of the packet to be transmitted to the host based on the second reception credit information.

12. The controller of claim 10, further comprising:
a memory storing a correspondence table, wherein the packet generation circuit is configured to determine the transmission size by referencing the correspondence table.

13. The controller of claim 12, wherein the correspondence table defines a plurality of data-type-specific relationships between the size of free space and the transmission size.

14. The controller of claim 10, wherein the packet is a Transaction Layer Packet (TLP) compliant with PCI Express (PCIe) standards.

15. A method for controlling a memory system in communication with a host, the method comprising:
acquiring, from the host, reception credit information indicating a size of free space in a reception buffer of the host; and
adjusting a transmission size of a packet to be transmitted to the host based on the acquired reception credit information.

16. The method of claim 15, wherein acquiring the reception credit information includes receiving an initial flow control message during a communication link setup procedure.

17. The method of claim 15, further comprising:
after transmitting a data packet, receiving an updated flow control message from the host indicating a change in the size of available space of the reception buffer of the host; and
updating the transmission size for a subsequent data packet based on the updated flow control message.

18. The method of claim 15, wherein determining the transmission size comprises:
referencing a correspondence table that associates a plurality of ranges of available space with a plurality of transmission sizes.

19. The method of claim 15, further comprising:
identifying a type of data contained within the data packet; and
wherein determining the transmission size is based on both the acquired reception credit information and the identified type of data.

20. The method of claim 15, further comprising:
receiving a read command from the host; and
reading data from a non-volatile memory within the memory system in response to the read command, wherein the packet includes the read data.
